(19) United States
(12) Patent Application Publication
(10) Pub. No.: US 2024/0344924 A1
(43) Pub. Date: Oct. 17, 2024

(54) DISPLAY PANEL INSPECTION DEVICE AND DISPLAY PANEL INSPECTION METHOD USING THE SAME

(71) Applicant: Samsung Display Co., LTD., Yongin-si (KR)

(72) Inventors: KI-YONG PARK, Yongin-si (KR); WANGSU LEE, Yongin-si (KR)

(73) Assignee: Samsung Display Co., LTD., Yongin-si (KR)

(21) Appl. No.: 18/581,702

(22) Filed: Feb. 20, 2024

(30) Foreign Application Priority Data
Apr. 11, 2023 (KR) 10-2023-0047517

(51) Int. Cl. G01M 7/08

(52) U.S. Cl. CPC G01M 7/08

(57) ABSTRACT

A display panel inspection device includes a base plate including a seating area that seats a display panel, and a peripheral area adjacent to the seating area, and a jig disposed in the peripheral area of the base plate, having a hollow shape, and including a body defining first grooves recessed from an inside to an outside of a corner.

### CROSS-REFERENCE TO RELATED APPLICATION(S)

This application claims priority to and benefits of Korean Patent Application No. 10-2023-0047517 under 35 USC § 119, filed on Apr. 11, 2023 in the Korean Intellectual Property Office (KIPO), the entire contents of which are incorporated herein by reference.

### BACKGROUND

### 1. Technical Field

Embodiments relate to a display panel inspection device and a display panel inspection method using the same.

### 2. Description of the Related Art

A display device may include a display panel that displays an image. The display panel may be exposed to various impacts during a manufacturing process. Specifically, an impact may be applied to the display panel in case that the display panel is transported or an inspection process for the display panel is performed. Cracks and bruises may occur in the display panel due to such an impact.

### SUMMARY

Embodiments provide a display panel inspection device with improved reliability.

Embodiments provide a display panel inspection method using the display panel inspection device.

A display panel inspection device according to an embodiment of the disclosure may include a base plate including a seating area that seats a display panel, and a peripheral area adjacent to the seating area, and a jig disposed in the peripheral area of the base plate, having a hollow shape, and including a body defining first grooves recessed from an inside to an outside of a corner.

In an embodiment, the jig may further include a first impact member inserted into at least one of the first grooves. The first impact member may protrude from the corner of the body toward a center of the base plate.

In an embodiment, the body of the jig may define second grooves recessed from an inner edge to an outer edge.

In an embodiment, the jig may further include a second impact member inserted into at least one of the second grooves. The second impact member may protrude from the inner edge of the body toward a center of the base plate.

In an embodiment, the jig may further include a third impact member inserted into at least one of the second grooves. A surface of the third impact member toward the center of the base plate and the inner edge of the body may be located on a same straight line.

In an embodiment, the jig may further include a fourth impact member inserted into at least one of the second grooves. The fourth impact member may protrude from the inner edge of the body toward a center of the base plate, and may cover a surface of the inner edge of the body.

In an embodiment, the base plate and the jig may be movable in a direction.

In an embodiment, the base plate and the jig may be rotatable with respect to a rotation axis passing through a center of the base plate and extending in a thickness direction of the base plate.

A display panel inspection method according to an embodiment of the disclosure may include seating a display panel in a seating area of a base plate including the seating area and a peripheral area adjacent to the seating area, moving the base plate, a jig disposed in the peripheral area on the base plate and having a hollow shape, and the display panel in a direction, and colliding the display panel with the jig.

In an embodiment, the colliding of the display panel with the jig may include stopping movement of the base plate and the jig.

In an embodiment, the colliding of the display panel with the jig may include moving the base plate and the jig in an opposite direction that is opposite to the direction.

In an embodiment, the display panel inspection method may further include calculating an amount of impact applied to the display panel. In the calculating of the amount of impact applied to the display panel, the moving of the base plate, the jig and the display panel, and the colliding of the display panel with the jig may be repeatedly performed.

In an embodiment, the calculating of the amount of impact applied to the display panel may include a first moving step of moving the base plate, the jig and the display panel at a first speed, and a second moving step of moving the base plate, the jig and the display panel at a second speed greater than the first speed after the first moving step.

In an embodiment, the jig may include a body defining first grooves recessed from an inside to an outside of a corner and second grooves recessed from an inner edge to an outer edge.

In an embodiment, the jig may further include a first impact member inserted into at least one of the first grooves. The first impact member may protrude from the corner of the body toward a center of the base plate.

In an embodiment, in the colliding of the display panel with the jig, the display panel may collide with the first impact member.

In an embodiment, the jig may further include a second impact member inserted into at least one of the second grooves. The second impact member may protrude from the inner edge of the body toward a center of the base plate.

In an embodiment, in the colliding of the display panel with the jig, the display panel may collide with the second impact member.

In an embodiment, the jig may further include a third impact member inserted into at least one of the second grooves. A surface of the third impact member toward a center of the base plate and the inner edge of the body may be located on a same straight line.

In an embodiment, the display panel inspection method may further include rotating the base plate and the jig with respect to a rotation axis passing through a center of the base plate and extending in a thickness direction of the base plate.

In a display panel inspection device according to embodiments of the disclosure, a jig disposed on a base plate may include a body and at least one of first, second, third and fourth impact members detachable from the body. An amount of impact applied to a display panel may be calculated by repeatedly colliding the display panel with at least one of the first, second, third and fourth impact members. A speed of transporting the display panel during processes of manufacturing the display panel may be adjusted through the calculated amount of impact. Accordingly, cracks in corners and bruises in the display panel, which may occur during the processes of manufacturing the display panel, may be prevented.

### BRIEF DESCRIPTION OF THE DRAWINGS

FIGS. 1 and 2 are schematic perspective views illustrating a display panel inspection device according to an embodiment of the disclosure.

FIG. 3 is an enlarged schematic plan view of a base plate and a jig included in the display panel inspection device of FIG. 1.

FIGS. 4 and 5 are schematic plan views illustrating an example of a display panel inspection method using the display panel inspection device of FIG. 1.

FIGS. 6 and 7 are schematic plan views illustrating another example of a display panel inspection method using the display panel inspection device of FIG. 1.

### DETAILED DESCRIPTION OF THE EMBODIMENTS

The disclosure will now be described more fully hereinafter with reference to the accompanying drawings, in which embodiments are shown. This disclosure may, however, be embodied in different forms and should not be construed as limited to the embodiments set forth herein. Rather, these embodiments are provided so that this disclosure will be thorough and complete, and will fully convey the scope of the disclosure to those skilled in the art.

In the drawings, sizes, thicknesses, ratios, and dimensions of the elements may be exaggerated for ease of description and for clarity. Like numbers refer to like elements throughout.

As used herein, the singular forms, “a,” “an,” and “the” are intended to include the plural forms as well, unless the context clearly indicates otherwise.

In the specification and the claims, the term “and/or” is intended to include any combination of the terms “and” and “or” for the purpose of its meaning and interpretation. For example, “A and/or B” may be understood to mean any combination including “A, B, or A and B.” The terms “and” and “or” may be used in the conjunctive or disjunctive sense and may be understood to be equivalent to “and/or.”

For the purposes of this disclosure, the phrase “at least one of A and B” may be construed as A only, B only, or any combination of A and B. Also, “at least one of X, Y, and Z” and “at least one selected from the group consisting of X, Y, and Z” may be construed as X only, Y only, Z only, or any combination of two or more of X, Y, and Z.

It will be understood that, although the terms first, second, etc., may be used herein to describe various elements, these elements should not be limited by these terms. These terms are only used to distinguish one element from another element. For example, a first element may be referred to as a second element, and similarly, a second element may be referred to as a first element without departing from the scope of the disclosure.

The terms “comprises,” “comprising,” “includes,” and/or “including,”, “has,” “have,” and/or “having,” and variations thereof when used in this specification, specify the presence of stated features, integers, steps, operations, elements, components, and/or groups thereof, but do not preclude the presence or addition of one or more other features, integers, steps, operations, elements, components, and/or groups thereof.

“About” or “approximately” or “substantially” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value.

Unless otherwise defined or implied herein, all terms (including technical and scientific terms) used herein have the same meaning as commonly understood by one of ordinary skill in the art to which the disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

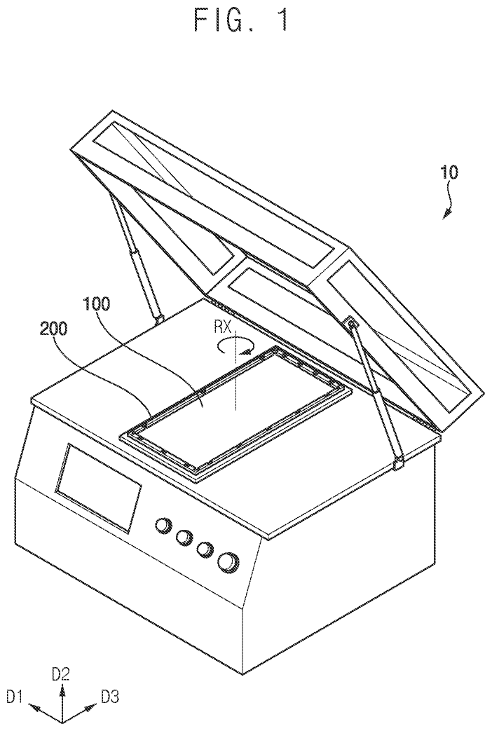

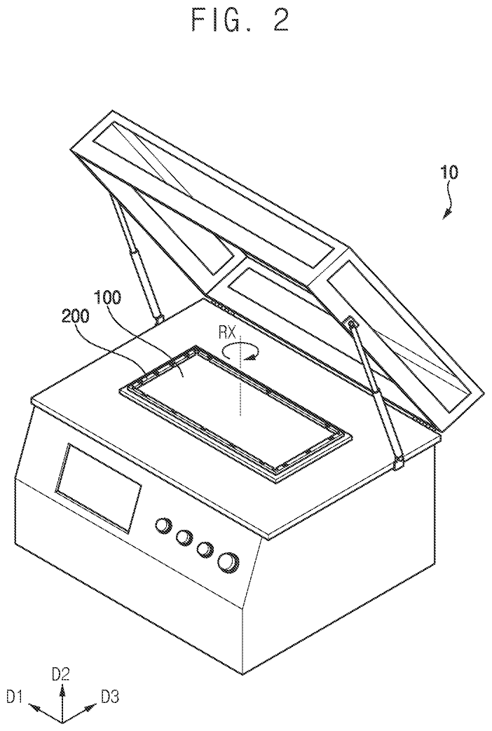

FIGS. 1 and 2 are schematic perspective views illustrating a display panel inspection device according to an embodiment of the disclosure.

Referring to FIGS. 1 and 2, a display panel inspection device 10 may include a base plate 100 and a jig 200.

The jig 200 may be disposed on the base plate 100. The jig 200 may extend along an edge of the base plate 100. The jig 200 may have a hollow shape. For example, the jig 200 may have a hollow rectangular planar shape. The jig 200 may be fixed to the base plate 100. In other embodiments, the jig 200 may be separated from the base plate 100.

The base plate 100 and the jig 200 may be movable in a same direction. For example, the base plate 100 and the jig 200 may be movable in a first direction D1 and in a direction opposite to the first direction D1. In other words, the base plate 100 and the jig 200 may vibrate in the first direction D1 and in the direction opposite to the first direction D1.

The base plate 100 and the jig 200 may be rotatable. Specifically, the base plate 100 and the jig 200 may be rotatable with respect to a rotation axis RX passing through a center of the base plate 100 and extending in a second direction D2 intersecting the first direction D1. The second direction D2 may be a thickness direction of the base plate 100. For example, the second direction D2 may be perpendicular to the first direction D1.

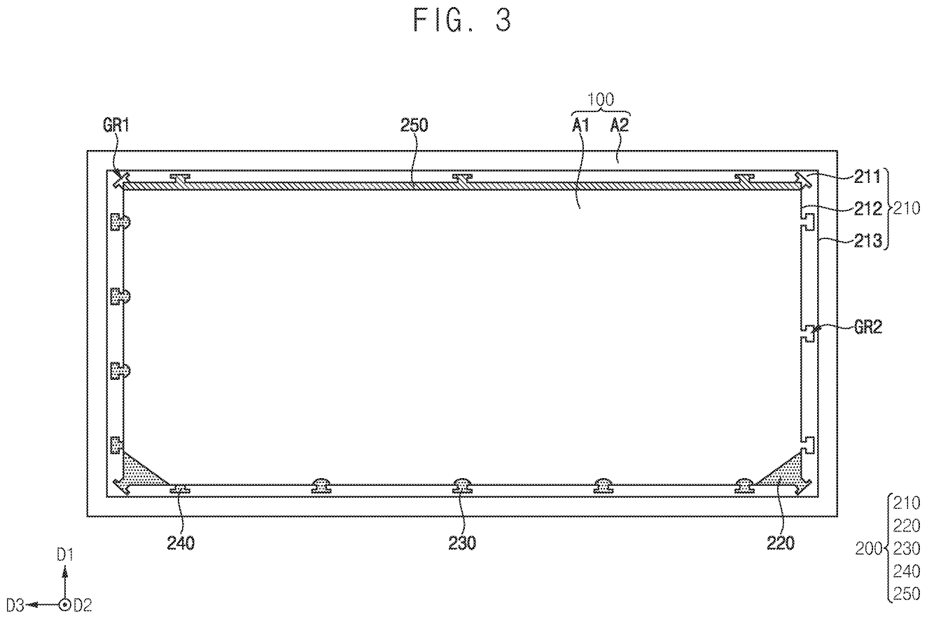

FIG. 3 is an enlarged schematic plan view of a base plate and a jig included in the display panel inspection device of FIG. 1.

Referring to FIG. 3, the base plate 100 may include a seating area A1 and a peripheral area A2.

The seating area A1 may be an area in which a display panel, which is an object to be inspected, is seated. The seating area A1 may be an area exposed by the jig 200.

The peripheral area A2 may be located adjacent to (e.g., around) the seating area A1. For example, the peripheral area A2 may entirely surround the seating area A1. The peripheral area A2 may be an area in which the jig 200 is disposed. For example, the jig 200 may be disposed in the peripheral area A2 on the base plate 100.

The jig 200 may include a body 210 and at least one of a first impact member 220, a second impact member 230, a third impact member 240 and a fourth impact member 250.

The body 210 may define first grooves GR1 and second grooves GR2. Each of the first grooves GR1 may be a recessed portion from an inside to an outside of a corner 211 of the body 210. Each of the second grooves GR2 may be a recessed portion from an inner edge 212 to an outer edge 213 of the body 210.

Each of the first, second, third and fourth impact members 220, 230, 240 and 250 may be coupled to the body 210. In other embodiments, each of the first, second, third and fourth impact members 220, 230, 240 and 250 may be separated from the body 210. For example, each of the first, second, third and fourth impact members 220, 230, 240 and 250 may be detachable from the body 210.

In case that the jig 200 includes the first impact member 220, the first impact member 220 may be inserted into at least one of the first grooves GR1. In an embodiment, the first impact member 220 inserted into at least one of the first grooves GR1 may protrude from the corner 211 of the body 210 toward the center of the base plate 100. The first impact member 220 may cover the inside of the corner 211 of the body 210.

In case that the jig 200 includes the second impact member 230, the second impact member 230 may be inserted into at least one of the second grooves GR2. In an embodiment, the second impact member 230 inserted into at least one of the second grooves GR2 may protrude from the inner edge 212 of the body 210 toward the center of the base plate 100.

In case that the jig 200 includes the third impact member 240, the third impact member 240 may be inserted into at least one of the second grooves GR2. In an embodiment, a surface toward the center of the base plate 100 of the third impact member 240 inserted into at least one of the second grooves GR2 may be located on a same straight line as the inner edge 212 of the body 100. For example, the third impact member 240 may not protrude from the inner edge 212 of the body 210.

In case that the jig 200 includes the fourth impact member 250, the fourth impact member 250 may be inserted into at least one of the second grooves GR2. In an embodiment, the fourth impact member 250 inserted into at least one of the second grooves GR2 may protrude from the inner edge 212 of the body 210 toward the center of the base plate 100. The fourth impact member 250 inserted into at least one of the second grooves GR2 may cover one surface of the inner edge 212 of the body 210. For example, the fourth impact member 250 may extend in a third direction D3 intersecting each of the first direction D1 and the second direction D2. The third direction D3 may be perpendicular to each of the first direction D1 and the second direction D2.

A position of the first grooves GR1 into which the first impact member 220 is inserted and a position of the second grooves GR2 into which each of the second, third and fourth impact members 230, 240 and 250 is inserted may be variously set according to a size of the display panel, a shape of the display panel, an evaluation target, or the like.

In an embodiment, each of the first, second and third impact members 220, 230 and 240 may include a material different from that of the fourth impact member 250. For example, each of the first, second and third impact members 220, 230 and 240 may include stainless steel (SUS), and the fourth impact member 250 may include polyethylene terephthalate (PET). However, the disclosure is not limited thereto.

At least one of the first, second, third and fourth impact members 220, 230, 240 and 250 may be coupled to the body 210. In an embodiment, only some of the first, second, third and fourth impact members 220, 230, 240 and 250 may be coupled to the body 210. For example, the jig 200 may include only some of the first, second, third and fourth impact members 220, 230, 240 and 250.

For example, the first impact member 220 may be inserted into at least one of the first grooves GR1, and the second, third and fourth impact members 230, 240 and 250 may not be inserted into the second grooves GR2, respectively. For example, the jig 200 may include the first impact member 220, and may not include the second, third and fourth impact members 230, 240 and 250.

As another example, the second impact member 230 may be inserted into at least one of the second grooves GR2, and the first, third and fourth impact members 220, 240 and 250 may not be inserted into the first and second grooves GR1 and GR2, respectively. For example, the jig 200 may include the second impact member 230, and may not include the first, third and fourth impact members 220, 240 and 250.

As still another example, the first and third impact members 220 and 240 may be inserted into at least one of the first grooves GR1 and at least one of the second grooves GR2, respectively, and the second and fourth impact members 230 and 250 may not be inserted into the second grooves GR2, respectively. For example, the jig 200 may include the first and third impact members 220 and 240, and may not include the second and fourth impact members 230 and 250.

However, the disclosure is not limited thereto. In other embodiments, all of the first, second, third and fourth impact members 220, 230, 240 and 250 may be coupled to the body 210. For example, the jig 200 may include all of the first, second, third and fourth impact members 220, 230, 240 and 250.

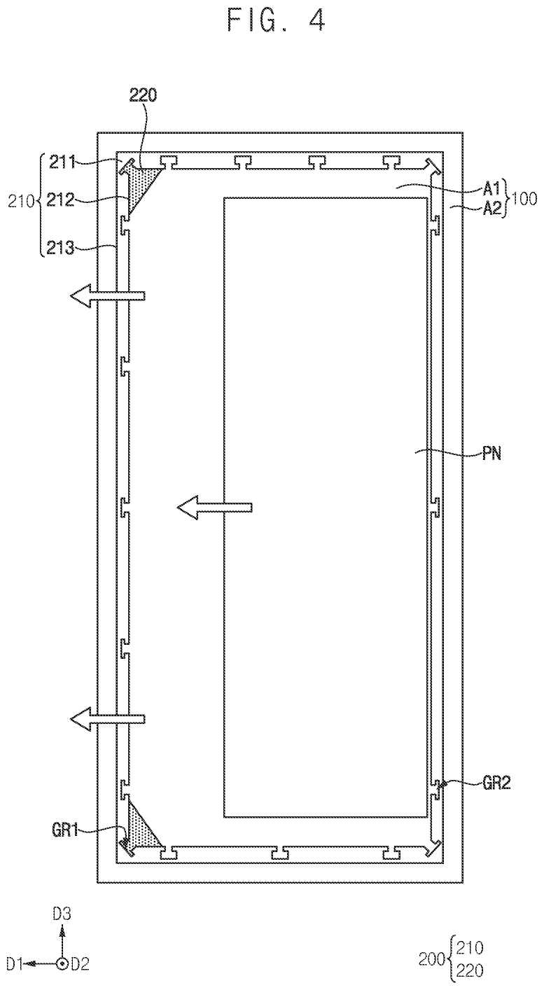

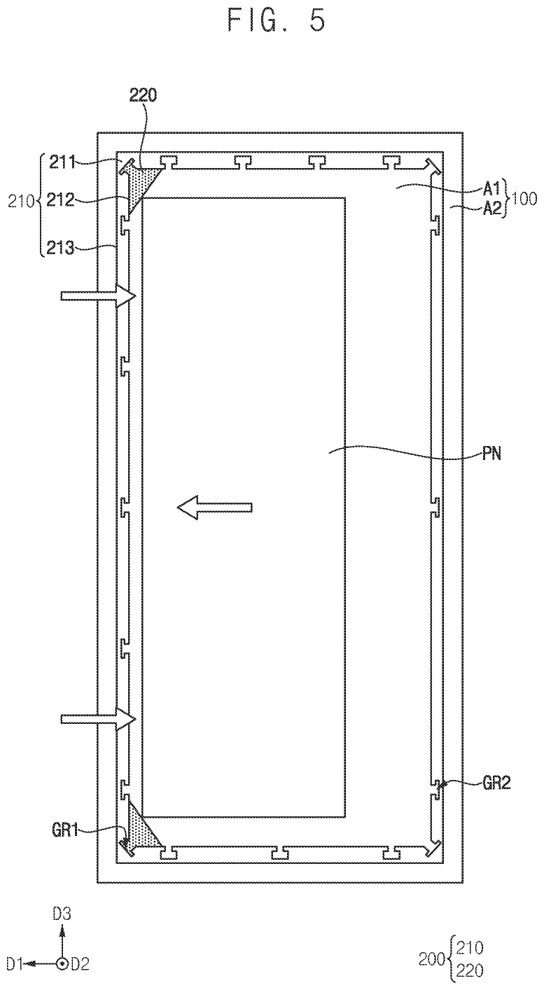

FIGS. 4 and 5 are schematic plan views illustrating an example of a display panel inspection method using the display panel inspection device of FIG. 1.

Referring to FIG. 4, the jig 200 may be disposed in the peripheral area A2 on the base plate 100. A display panel PN may be seated in the seating area A1 on the base plate 100. The display panel PN may not be fixed to the base plate 100. The jig 200 may surround the display panel PN.

The jig 200 may include the body 210 and the first impact members 220. The first impact members 220 may be inserted into some of the first grooves GR1.

The base plate 100 and the jig 200 may move in the first direction D1. Accordingly, the display panel PN seated on the base plate 100 may also move in the first direction D1. For example, the display panel PN may slide in the first direction D1 on the base plate 100.

Referring to FIG. 5, the base plate 100 and the jig 200 may move in the direction opposite to the first direction D1, or may stop.

In an embodiment, the base plate 100 and the jig 200 may move in the direction opposite to the first direction D1. At this time, the display panel PN may continuously move in the first direction D1 due to inertia to move in the first direction D1. Accordingly, the display panel PN may collide with the jig 200 that moves in the opposite direction to the display panel PN. Specifically, some of corners of the display panel PN may collide with the first impact members 220 that protrude from the corner 211 of the body 210.

In another embodiment, the base plate 100 and the jig 200 may stop. At this time, the display panel PN may continuously move in the first direction D1 due to inertia to move in the first direction D1. Accordingly, the display panel PN may collide with the stopped jig 200. Specifically, some of the corners of the display panel PN may collide with the first impact members 220 that protrude from the corner 211 of the body 210.

A process of colliding the display panel PN with the jig 200 by moving the base plate 100, the jig 200 and the display panel PN may be repeatedly performed.

After colliding the display panel PN with the jig 200, a speed of moving the base plate 100, the jig 200 and the display panel PN may be increased. In other words, the display panel PN may collide with the jig 200 by moving the base plate 100, the jig 200 and the display panel PN at a first speed, and the display panel PN may collide with the jig 200 by moving the base plate 100, the jig 200 and the display panel PN at a second speed greater than the first speed. For example, the second speed may be about 10 mm/s greater than the first speed, but the disclosure is not limited thereto.

The process of colliding the display panel PN with the jig 200 by moving the base plate 100, the jig 200 and the display panel PN may be repeatedly performed until a crack defect occurs in the corner of the display panel PN that collides with the jig 200. In case that the crack defect occurs in the corner of the display panel PN, an amount of impact applied to the display panel PN may be calculated. A speed of transporting the display panel PN in processes of manufacturing the display panel PN may be guided through the calculated impact amount. Accordingly, crack defects in the corner, which may occur during transporting the display panel PN in the processes of manufacturing the display panel PN, may be prevented.

Although FIGS. 4 and 5 illustrate that the jig 200 includes two first impact members 220, the disclosure is not limited thereto. In other embodiments, the jig 200 may include one or three or more first impact members 220, or may further include some of the second, third and fourth impact members 230, 240 and 250.

Although FIGS. 4 and 5 illustrate the process of colliding some corners of the display panel PN with the jig 200, the disclosure is not limited thereto. By rotating the base plate 100 and the jig 200, a process of colliding other corners of the display panel PN with the jig 200 may be performed.

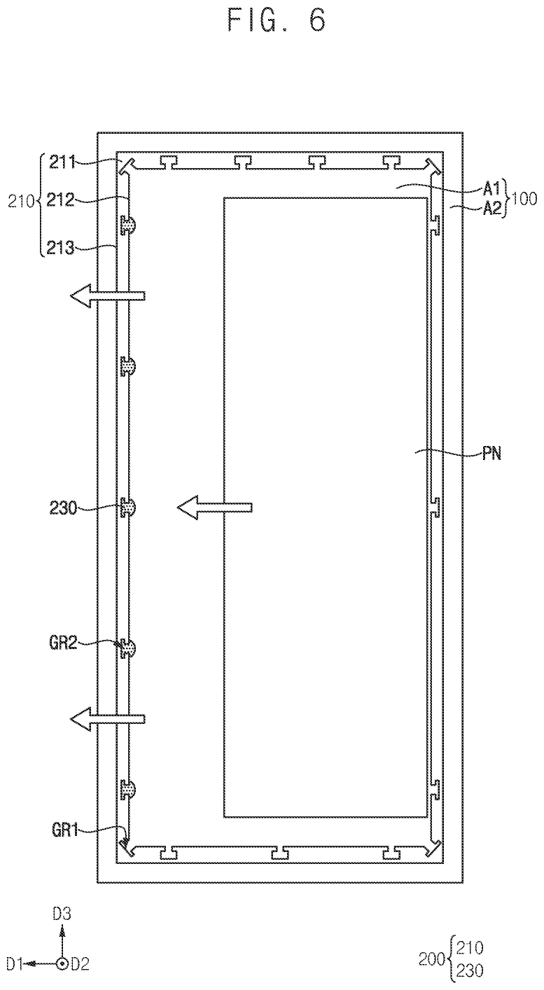

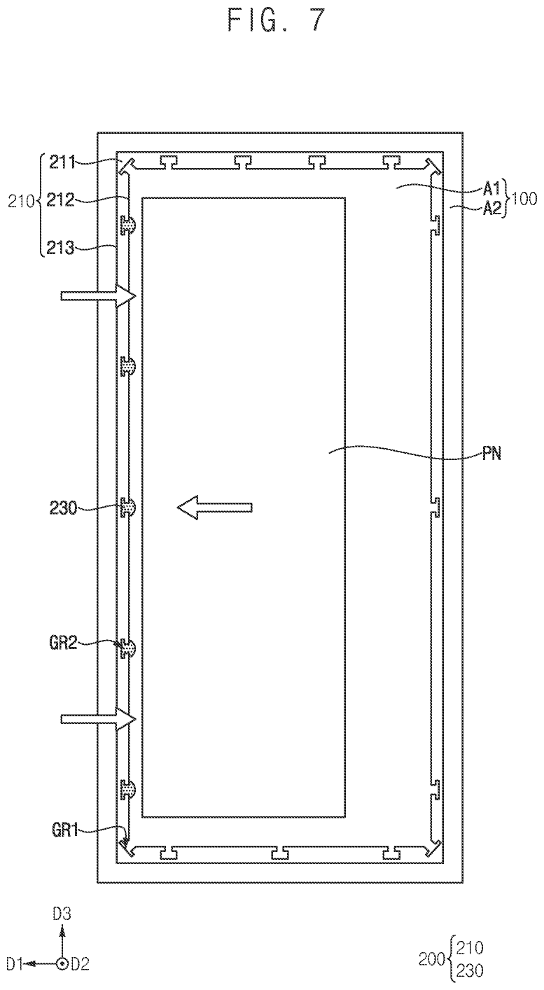

FIGS. 6 and 7 are schematic plan views illustrating another example of a display panel inspection method using the display panel inspection device of FIG. 1.

Hereinafter, descriptions overlapping with the display panel inspection method using the display panel inspection device 10 described with reference to FIGS. 4 and 5 will be omitted or simplified in the interest of brevity.

Referring to FIG. 6, the jig 200 may be disposed in the peripheral area A2 on the base plate 100, and the display panel PN may be seated in the seating area A1 on the base plate 100.

The jig 200 may include the body 210 and the second impact members 230. The second impact members 230 may be inserted into some of the second grooves GR2.

The base plate 100 and the jig 200 may move in the first direction D1. Accordingly, the display panel PN may also move in the first direction D1.

Referring to FIG. 7, the base plate 100 and the jig 200 may move in the direction opposite to the first direction D1, or may stop.

In an embodiment, the base plate 100 and the jig 200 may move in the direction opposite to the first direction D1. At this time, the display panel PN may continuously move in the first direction D1 due to inertia. Accordingly, the display panel PN may collide with the jig 200 that moves in the opposite direction to the display panel PN. Specifically, one surface of the display panel PN may collide with the second impact members 230 that protrude from the inner edge 212 of the body 210.

In another embodiment, the base plate 100 and the jig 200 may stop. At this time, the display panel PN may continuously move in the first direction D1 due to inertia. Accordingly, the display panel PN may collide with the stopped jig 200. Specifically, one surface of the display panel PN may collide with the second impact members 230 that protrude from the inner edge 212 of the body 210.

A process of colliding the display panel PN with the jig 200 by moving the base plate 100, the jig 200 and the display panel PN may be repeatedly performed.

After colliding the display panel PN with the jig 200, a speed of moving the base plate 100, the jig 200 and the display panel PN may be increased. In other words, the display panel PN may collide with the jig 200 by moving the base plate 100, the jig 200 and the display panel PN at the first speed, and the display panel PN may collide with the jig 200 by moving the base plate 100, the jig 200 and the display panel PN at the second speed.

The process of colliding the display panel PN with the jig 200 by moving the base plate 100, the jig 200 and the display panel PN may be repeatedly performed until a bruise defect occurs on the one surface of the display panel PN that collides with the jig 200. In case that the bruise defect occurs in the display panel PN, an amount of impact applied to the display panel PN may be calculated. A speed of transporting the display panel PN in processes of manufacturing the display panel PN may be guided through the calculated impact amount. Accordingly, bruise defects in the display panel PN, which may occur during transporting the display panel PN in the processes of manufacturing the display panel PN, may be prevented.

Although FIGS. 6 and 7 illustrate that the jig 200 includes five second impact members 230, the disclosure is not limited thereto. In other embodiments, the jig 200 may include four or less or six or more second impact members 230, or may further include some of the first, third and fourth impact members 220, 240 and 250.

Although FIGS. 6 and 7 illustrate the process of colliding the one surface of the display panel PN with the jig 200, the disclosure is not limited thereto. By rotating the base plate 100 and the jig 200, a process of colliding other surfaces of the display panel PN with the jig 200 may be performed.

In the display panel inspection device 10 according to an embodiment of the disclosure, the jig 200 disposed on the base plate 100 may include at least one of the first, second, third and fourth impact members 220, 230, 240 and 250 detachable from the body 210. By repeatedly colliding the display panel PN with at least one of the first, second, third and fourth impact members 220, 230, 240 and 250, an amount of impact applied to the display panel PN may be calculated. A speed of transporting the display panel PN in the processes of manufacturing the display panel PN may be adjusted through the calculated impact amount. Accordingly, crack defects in the corner and bruise defects in the display panel PN, which may occur in the processes of manufacturing the display panel PN, may be prevented.

The disclosure can be applied to a manufacturing process of various display devices. For example, the disclosure is applicable to a manufacturing process of various display devices such as display devices for vehicles, ships and aircraft, portable communication devices, display devices for exhibition or information transmission, medical display devices, and the like.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the disclosure. Accordingly, all such modifications are intended to be included within the scope of the disclosure. Therefore, it is to be understood that the foregoing is illustrative of various embodiments and is not to be construed as limited to the specific embodiments disclosed, and that modifications to the disclosed embodiments, as well as other embodiments, are intended to be included within the scope of the disclosure.

What is claimed is:

1. A display panel inspection device, comprising:
a base plate including:
a seating area that seats a display panel; and
a peripheral area adjacent to the seating area; and
a jig disposed in the peripheral area of the base plate, having a hollow shape, and including a body defining first grooves recessed from an inside to an outside of a corner.

2. The display panel inspection device of claim 1, wherein
the jig further includes a first impact member inserted into at least one of the first grooves, and
the first impact member protrudes from the corner of the body toward a center of the base plate.

3. The display panel inspection device of claim 1, wherein the body of the jig defines second grooves recessed from an inner edge to an outer edge.

4. The display panel inspection device of claim 3, wherein
the jig further includes a second impact member inserted into at least one of the second grooves, and
the second impact member protrudes from the inner edge of the body toward a center of the base plate.

5. The display panel inspection device of claim 3, wherein
the jig further includes a third impact member inserted into at least one of the second grooves, and
a surface of the third impact member toward the center of the base plate and the inner edge of the body are located on a same straight line.

6. The display panel inspection device of claim 3, wherein
the jig further includes a fourth impact member inserted into at least one of the second grooves, and
the fourth impact member protrudes from the inner edge of the body toward a center of the base plate, and covers a surface of the inner edge of the body.

7. The display panel inspection device of claim 1, wherein the base plate and the jig are movable in a direction.

8. The display panel inspection device of claim 1, wherein the base plate and the jig are rotatable with respect to a rotation axis passing through a center of the base plate and extending in a thickness direction of the base plate.

9. A display panel inspection method, comprising:
seating a display panel in a seating area of a base plate including the seating area and a peripheral area adjacent to the seating area;
moving the base plate, a jig disposed in the peripheral area of the base plate and having a hollow shape, and the display panel in a direction; and
colliding the display panel with the jig.

10. The display panel inspection method of claim 9, wherein the colliding of the display panel with the jig includes:
stopping movement of the base plate and the jig.

11. The display panel inspection method of claim 9, wherein the colliding of the display panel with the jig includes:
moving the base plate and the jig in an opposite direction that is opposite to the direction.

12. The display panel inspection method of claim 9, further comprising:
calculating an amount of impact applied to the display panel,
wherein in the calculating of the amount of impact applied to the display panel, the moving of the base plate, the jig and the display panel, and the colliding of the display panel with the jig are repeatedly performed.

13. The display panel inspection method of claim 12, wherein the calculating of the amount of impact applied to the display panel includes:
a first moving step of moving the base plate, the jig and the display panel at a first speed; and
a second moving step of moving the base plate, the jig and the display panel at a second speed greater than the first speed after the first moving step.

14. The display panel inspection method of claim 9, wherein the jig includes a body defining first grooves recessed from an inside to an outside of a corner and second grooves recessed from an inner edge to an outer edge.

15. The display panel inspection method of claim 14, wherein
the jig further includes a first impact member inserted into at least one of the first grooves, and
the first impact member protrudes from the corner of the body toward a center of the base plate.

16. The display panel inspection method of claim 15, wherein
in the colliding of the display panel with the jig, the display panel collides with the first impact member.

17. The display panel inspection method of claim 14, wherein
the jig further includes a second impact member inserted into at least one of the second grooves, and
the second impact member protrudes from the inner edge of the body toward a center of the base plate.

18. The display panel inspection method of claim 17, wherein
in the colliding of the display panel with the jig, the display panel collides with the second impact member.

19. The display panel inspection method of claim 14, wherein
the jig further includes a third impact member inserted into at least one of the second grooves, and
a surface of the third impact member toward a center of the base plate and the inner edge of the body are located on a same straight line.

20. The display panel inspection method of claim 9, further comprising:
rotating the base plate and the jig with respect to a rotation axis passing through a center of the base plate and extending in a thickness direction of the base plate.
